(19) United States
(12) Patent Application Publication
(10) Pub. No.: US 2019/0171402 A1
(43) Pub. Date: Jun. 6, 2019

(54) ELECTRONIC SHELF LABEL SYSTEM AND DISPLAY DEVICE

(71) Applicant: Japan Display Inc., Tokyo (JP)

(72) Inventors: Koji ISHIZAKI, Tokyo (JP); Taro ICHIMURA, Tokyo (JP); Takao AMBAI, Tokyo (JP)

(21) Appl. No.: 16/209,334

(22) Filed: Dec. 4, 2018

(30) Foreign Application Priority Data
Dec. 4, 2017 (JP) 2017-232683

(51) Int. Cl. G06F 3/147; G06K 17/00; G06Q 20/20; G06Q 10/08; G09F 3/20

(52) U.S. Cl. CPC G06F 3/147; G06K 17/00; G06Q 20/201; G09G 2380/04; G09F 3/208; G09G 2330/021; G06Q 10/087

(57) ABSTRACT

According to one embodiment, a display device being enable communication with an external device is provided. The display device includes a display panel, a controller, a battery, and a power supply circuit. The controller is configured to control the display panel so as to display product data related to a product. The battery is configured to store electric power operating the display device. The power supply circuit is configured to supply electric power to the battery. The electric power is obtained by the communication with the external device.

### CROSS-REFERENCE TO RELATED APPLICATIONS

This application is based upon and claims the benefit of priority from Japanese Patent Application No. 2017-232683, filed Dec. 4, 2017, the entire contents of which are incorporated herein by reference.

### FIELD

Embodiments described herein relate generally to an electronic shelf label system and a display device.

### BACKGROUND

In general, for example, shelf labels on which names, prices, and the like of products are printed (displayed) are attached to display shelves on which products for sales are displayed in stores such as retail stores and supermarkets.

If a product price is changed in such a store, for example, the shelf label on which the pre-changed price is printed needs to be replaced with a shelf label on which a changed price is printed, which requires much labor.

Recently, a system of displaying data (hereinafter called product data) such as names and prices of products for sales in the store on electric shelf labels (electronic tags) (hereinafter called an electronic shelf label system) is well known.

The electronic shelf label system includes a server device which centrally manages the product data, and can display the product data on the electronic shelf labels by transmitting product data of the products to the electronic shelf labels corresponding to the products from the server device.

Such an electronic shelf label system can flexibly correspond to the above-mentioned change of product prices and the like without labor.

In the electronic shelf label system, however, works such as exchange of electric cells of the electronic shelf labels or charging of batteries are required and the convenience is small in this point.

### SUMMARY

The present application relates generally to an electronic shelf label system and a display device.

According to one embodiment, a display device being enable communication with an external device is provided. The display device includes a display panel, a controller, a battery, and a power supply circuit. The controller is configured to control the display panel so as to display product data related to a product. The battery is configured to store electric power operating the display device. The power supply circuit is configured to supply electric power to the battery. The electric power is obtained by the communication with the external device.

### BRIEF DESCRIPTION OF THE DRAWINGS

FIG. 1 is an illustration for explanation of an example of usage of a display device according to a first embodiment.

FIG. 2 is a block diagram showing an example of a configuration of an electronic shelf label system.

FIG. 3 is a diagram for explanation of an example of a configuration of an electrophoretic display panel.

FIG. 4 is a diagram for explanation of the electrophoretic display panel when displaying white color.

FIG. 5 is a diagram for explanation of the electrophoretic display panel when displaying black color.

FIG. 6 is a sequence chart showing an example of a processing procedure of displaying product data on a display device in the electronic shelf label system.

FIG. 7 is a sequence chart showing an example of a processing procedure of charging a battery of the display device in the electronic shelf label system.

FIG. 8 is a chart for explanation of an example of a time band in which the battery of the display device is charged.

FIG. 9 is a chart for explanation of an example of a time band in which the battery of the display device is charged.

FIG. 10 is a block diagram showing an example of a configuration of an electronic shelf label system according to a second embodiment.

FIG. 11 is a sequence chart showing an example of a processing procedure when charging a battery of the display device in the electronic shelf label system.

FIG. 12 is a sequence chart showing an example of a processing procedure of urging product data to blink on a specific display device 10.

FIG. 13 is a block diagram showing an example of a configuration of an electronic shelf label system according to a third embodiment.

FIG. 14 is a block diagram showing an example of a configuration of an electronic shelf label system according to a fourth embodiment.

### DETAILED DESCRIPTION

In general, according to one embodiment, a display device being enable communication with an external device includes a display panel, a controller, a battery and a power supply circuit. The controller is configured to control the display panel so as to display product data related to a product. The battery is configured to store electric power operating the display device. The power supply circuit is configured to supply electric power to the battery. The electric power is obtained by the communication with the external device.

Embodiments will be described hereinafter with reference to the accompanying drawings.

### First Embodiment

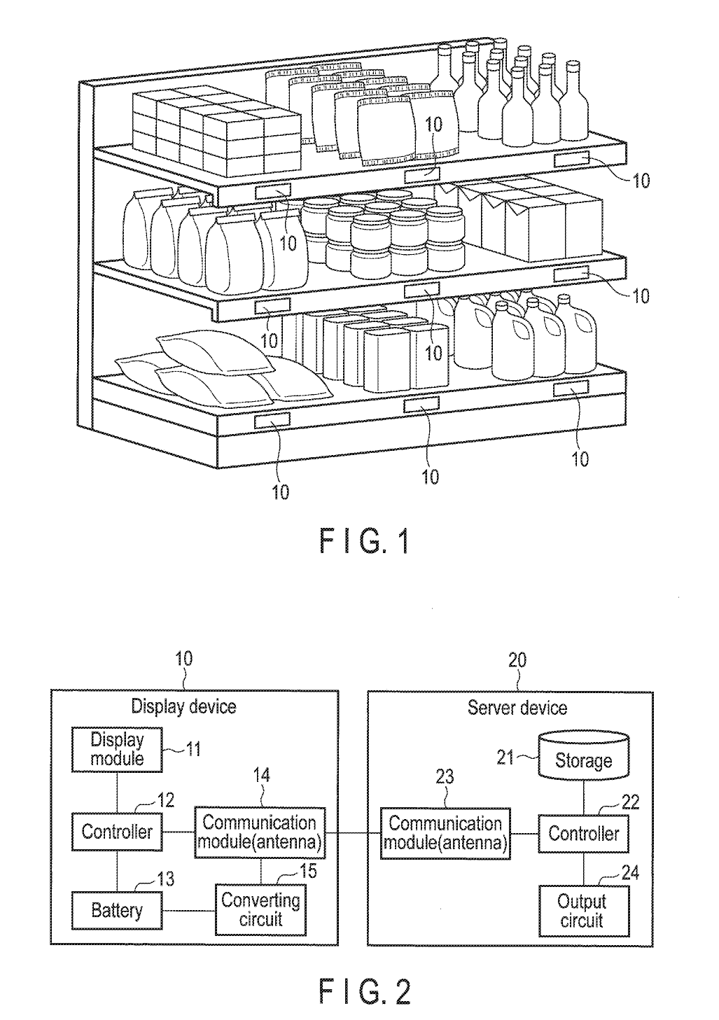

FIG. 1 is an illustration for explanation of an example of usage of a display device according to the present embodiment. As shown in FIG. 1, display devices 10 according to the present embodiment are attached to display shelves on which products are displayed in, for example, stores such as retail stores and supermarkets. As shown in FIG. 1, the display devices 10 are attached to the display shelves for the respective products.

The display devices 10 are, for example, electronic shelf labels including display panels, which display data of the products arranged close to the display devices 10 (hereinafter referred to as product data). The product data displayed on the display devices 10 include, for example, names, prices, and the like of the products but may include the other data.

Each of the display devices 10 includes a communication function and is connected to an external device such as a server device so as to enable communication with the device, which is not shown in FIG. 1. An electronic shelf label system (ESL system) includes the display devices 10 and the server device. The server device of the electronic shelf label system is, for example, an information processing device such as a personal computer (PC) which manages the product data displayed on each of the display devices 10 (display panel).

FIG. 2 is a block diagram showing a configuration of the electronic shelf label system (the display device 10 and the server device 20). FIG. 2 shows only one display device 10 for convenience, and illustration of the other display devices 10 is omitted. Each of the display devices 10 included in the electronic shelf label system includes the same configuration as that of the display device 10 shown in FIG. 2.

The display device 10 includes a display module 11, a controller 12, a battery 13, a communication module 14, and a converting circuit (power supply circuit) 15.

The display module 11 includes a display panel to display the product data, a display driver IC to drive the display panel, and the like. In the present embodiment, for example, an electrophoretic display panel having a display retaining property explained below is used as the display panel included in the display module 11.

The controller 12 includes, for example, a System on a Chip (SoC) or a microcomputer to control operations of the whole display device 10. The product data can be displayed on the display panel under control of the controller 12.

The battery 13 is a power storage unit configured to store electric power operating the display device 10. The display device 10 can be operated with the electric power stored in the battery 13 (i.e., the electric power supplied from the battery 13). The display device 10 includes the battery 13 in the present embodiment, but the display device 10 may include a power storage unit, different from battery 13, capable of storing the electric power operating the display device 10 and may include, for example, a capacitor or the like as the power storage unit.

The communication module 14 includes an antenna and the like for communication with the above-explained server device 20. The antenna is used to receive, for example, the product data managed by the server device 20. More specifically, the antenna receives radio waves (hereinafter referred to radio waves for display) transmitted from the server device 20 for displaying the product data on the display panel. The radio waves for display are radio waves modulated with the product data which are to be displayed on the display device 10. In this case, the controller 12 executes control to acquire the product data from the radio waves for display by demodulating the radio waves for display received by the antenna and to display the product data on the display panel.

The display device 10 according to the present embodiment is capable of, for example, charging the battery 13 with the electric power obtained by the communication with the server device 20 (i.e., supplying the electric power to the battery 13).

More specifically, the antenna included in the above-explained communication module 14 receives, for example, radio waves transmitted from the server device 20 to supply the electric power to the battery 13 (hereinafter referred to as radio waves for feeding). The converting circuit 15 converts the radio waves for feeding received by the antenna into the electric power and supplies the electric power to the battery 13.

The server device (ESL server) 20 is connected to the display device 10 so as to communicate with the display device 10. As shown in FIG. 2, the server device 20 includes a storage 21, a controller 22, a communication module 23, and an output circuit 24.

The product data managed by the server device 20 are stored in the storage 21 as explained above. The product data are stored in association with an ID (hereinafter referred to as a display device ID) to identify the display device 10 which is to display the product data, in the storage 21.

The controller 22 transmits the above-explained radio waves for display (i.e., radio waves modulated by the product data) to the display device 10 via the communication module 23 (antenna).

In addition, the controller 22 transmits the above-explained radio waves for feeding to the display device 10 via the communication module 23.

The controller 22 also executes control of transmission timing of the radio waves for display and the radio waves for feeding.

The output circuit 24 outputs, for example, an alert in response to the feeding (status) to the battery 13 included in the display device 10 as explained below.

In the display device 10 according to the present embodiment, the electrophoretic display panel is used as the display panel, and the electrophoretic display panel will be explained below in brief.

The display panel of the display device 10 according to the present embodiment is assumed to adopt, for example, electrophoretic scheme of secondary particle based microcapsule type. On such a display panel, the product data can be displayed by the electrophoretic phenomenon of particles dispersed in a liquid (solvent). The electrophoretic phenomenon is a phenomenon in which particles are disperse in a liquid, an electric field is applied to the particles, and the particles are thereby made electrophoretic in the liquid by the Coulomb force. For example, positively or negatively charged white (pigment) particles (electrophoretic particles) and negatively or positively charged black (pigment) (electrophoretic particles) can be dispersed in an achromatic and transparent liquid, and white, black and shades of gray can be displayed in accordance with the polarity, magnitude and time of the applied voltage.

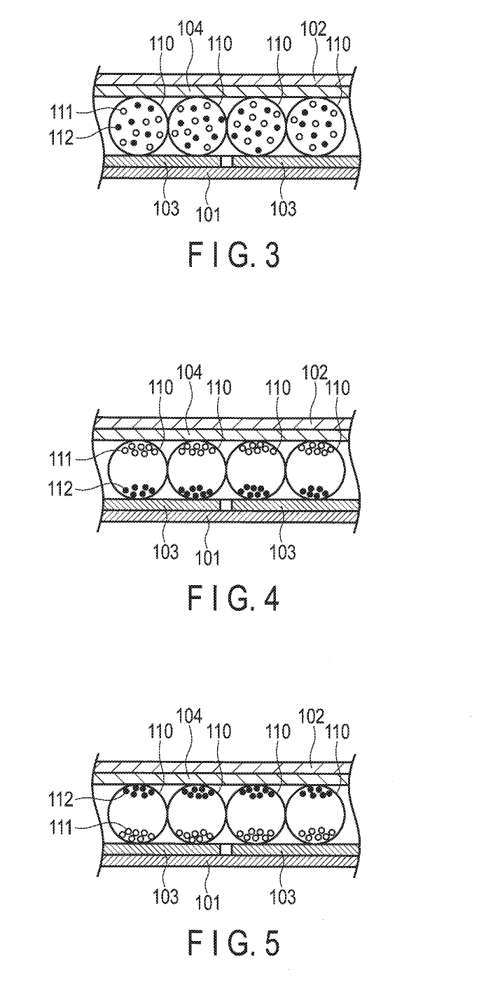

The configuration of the electrophoretic display panel will be hereinafter explained with reference to FIG. 3. As shown in FIG. 3, for example, the electrophoretic display panel includes a first substrate 101 and a second substrate 102, the first substrate 101 includes pixel electrodes 103 on the second substrate 102 side. In contrast, the second substrate 102 includes a flat common electrode 104 on the first substrate 101 side.

In the electrophoretic display panel, microcapsules 110 are disposed to be sandwiched between the pixel electrodes 103 and the common electrode 104.

The achromatic transparent liquid, white electrophoretic particles 111, and black electrophoretic particles 112 are sealed in the microcapsules 110. It is assumed that in the present embodiment, for example, the white electrophoretic particles 111 are charged negatively (−) and the black electrophoretic particles 112 are charged positively (+).

In such an electrophoretic display panel, white or black color can be displayed in accordance with a potential difference between the pixel electrodes 103 and the common electrode 104.

For example, if the electric potential of the pixel electrodes 103 is lower than the electric potential of the common electrode 104, in a case where the second substrate (transparent substrate) 102 side is the display surface, the white electrophoretic particles 111 charged negatively are attracted to the common electrode 104 side and the black electrophoretic particles 112 charged positively are attracted to the pixel electrode 103 side as shown in FIG. 4, and white color can be thereby displayed on the display surface.

In contrast, if the electric potential of the pixel electrodes 103 is higher than the electric potential of the common electrode 104, the white electrophoretic particles 111 are attracted to the pixel electrode 103 side and the black electrophoretic particles 112 are attracted to the common electrode 104 side as shown in FIG. 5, and black color can be thereby displayed on the display surface.

Since such an electrophoretic display panel has the display retaining property as explained above, for example, display of the product data can be maintained without supplying the electric power once the product data are displayed, and reduction in the power consumption can be implemented.

The electrophoretic scheme of secondary particle based microcapsule type is explained but a display panel employing the other scheme may be used in the present embodiment. For example, the liquid and the electrophoretic particles may be sealed not in the microcapsules but (in a layer) between the pixel electrodes 103 and the common electrode 104.

In addition, it has been explained that the display panel in the present embodiment is the electrophoretic display panel, but the display panel is not limited to the electrophoretic display panel and may be, for example, a reflective liquid crystal display panel or the like.

Next, operations of the electronic shelf label system (display device 10 and server device 20) according to the present embodiment will be explained.

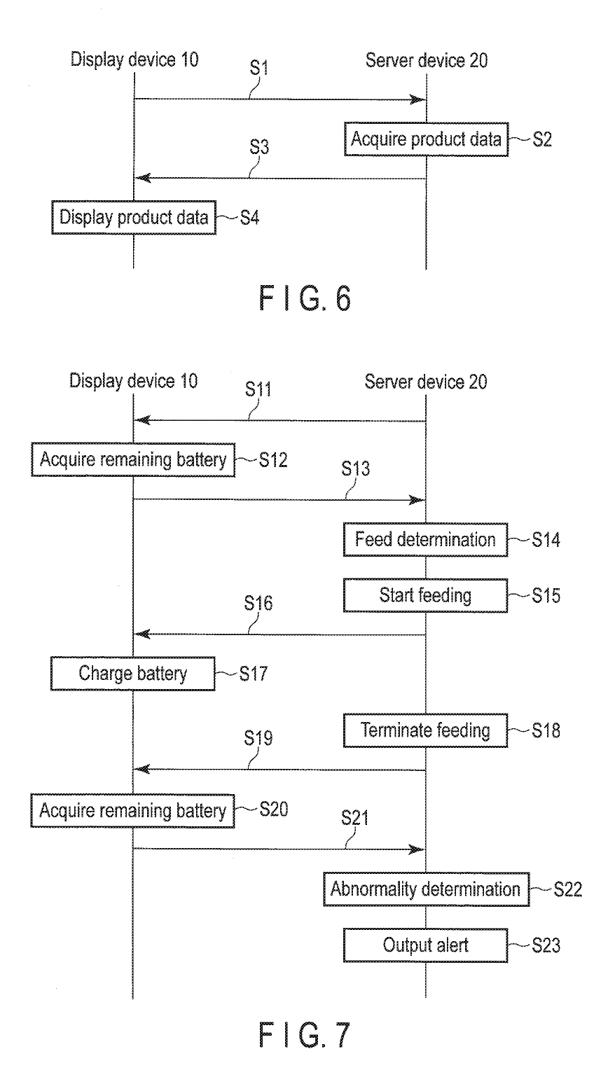

First, a processing procedure of displaying the product data on the display device 10 (i.e., rewriting the product data of the display devices 10) in the electronic shelf label system will be explained with reference to a sequence chart shown in FIG. 6.

It is assumed that the product data are displayed on the display panel by the above-explained display retaining property. In this case, the display device 10 (the controller 12) periodically transmits an inquiry of requirement for rewriting the product data to the server device 20 (step S1). The inquiry transmitted in step S1 is assumed to include a display device ID to identify the display device 10 transmitting the inquiry, and the like.

This inquiry (display device ID) is transmitted and received via the communication module 14 of the display device 10 and the communication module 23 (antenna), similarly to the product data. Data transmitted between the display device 10 and the server device 20, which will be explained below, are transmitted and receive in the same manner.

If the server device 20 (the controller 22) receives the inquiry from the display device 10 via the communication module 23, the controller 22 determines whether rewriting the product data on the display device 10 identified with the display device ID included in the inquiry (hereinafter referred to as target display device 10) is necessary or not. For example, if the current time reaches the time to rewrite the product data, the controller 22 determines that rewriting the product data on the target display device 10 is necessary. The time to rewrite the product data may be preset in, for example, the server device 20. In addition, if rewriting the product data is instructed by a manager, an employee, or the like of the store, the controller 22 may determine that rewriting the product data is necessary.

If it is determined that rewriting the product data is necessary, the controller 22 acquires the product data to be displayed on the target display device 10 from the storage 21 (step S2). The product data to be displayed on the target display device 10 are stored in association with the display device ID indicating the target display device 10 in the storage 21 as explained above. Therefore, the controller 22 acquires the product data stored in the storage 21 in association with the display device ID included in the received inquiry.

In this case, the controller 22 transmits the product data acquired in step S2 to the target display device 10 (step S3). In this case, the controller 22 transmits the radio waves acquired by modulating a predetermined carrier with the product data acquired in step S2, as radio waves for display, from the communication module 23 (antenna) to the display device 10. The radio waves for display are transmitted in a frequency band of, for example, 2.4 GHz or the like.

If the processing in step S3 is executed, the communication module 14 (antenna) receives the radio waves for display transmitted from the server device 20 (controller 22). The controller 12 acquires the product data from the radio waves for display by demodulating the radio waves for display received by the communication module 14 and displays the product data on the display panel included in the display module 11 (step S4).

In the present embodiment, for example, the product data displayed on the display panel can be rewritten at appropriate timing by executing the above-explained processing shown in FIG. 6. If it is determined that rewriting the product data in the server device 20 unnecessary, the processing in FIG. 6 is terminated.

The only processing executed between one display device 10 and the server device 20 has been explained with reference to FIG. 6, but the processing shown in FIG. 6 is executed between all of the display devices 10 attached to the display shelves in the store (i.e., all of the display devices 10 included in the electronic shelf label system) and the server device 20. In this case, for example, the inquiry explained in step S1 shown in FIG. 6 is assumed to be transmitted at the timing of causing no interference between the display devices 10.

The display device 10 according to the present embodiment includes a battery 13 and operates with the electric power supplied from the battery 13. For this reason, in the present embodiment, the battery 13 needs to be charged on the display device 10.

However, since a number of display devices 10 are used in the electronic shelf label system, work of charging the battery 13 for each of the display devices 10 may be very complicated and may require much labor.

In the present embodiment, the battery 13 of each display device 10 is charged by wireless feed. More specifically, the display device 10 charges the battery 13 by supplying the electric power obtained by the communication with the server device 20 (external device) to the battery 13.

A processing procedure of charging the battery 13 included in the display device 10 of the electronic shelf label system will be explained with reference to a sequence chart shown in FIG. 7.

In the present embodiment, for example, the server device 20 (controller 22) periodically requires the data on the display device 10 via the communication module 23 (step S11). The display device 10 serving as the data requirement destination in step S11 is hereinafter referred to as the target display device 10.

The controller 12 included in the target display device 10 acquires the amount of electric power (hereinafter referred to as remaining battery) stored in the battery 13 included in the target display device 10 in response to the requirement from the server device 20 (step S12).

If the processing in step S12 is executed, the controller 12 transmits (the data indicating) the remaining battery acquired in step S12 to the server device 20 in response to the requirement from the server device 20 (step S13).

Next, the controller 22 included in the server device 20 receives (acquires) the remaining battery transmitted in step S13 via the communication module 23. The controller 22 executes feed determination, based on the received remaining battery (step S14). The feed determination is the processing for determining whether the electric power needs to be fed to the battery 13 included in the target display device 10 (i.e., the battery 13 needs to be charged) or not and, for example, if the remaining battery is lower than a predetermined value, it is determined that the electric power needs to be fed to the battery 13.

If it is determined that the electric power needs to be fed to the battery 13, the controller 22 starts feeding the electric power to the battery 13 (i.e., charging the battery 13) (step S15).

In this case, the controller 22 transmits the radio waves for feeding to feed (supply) the electric power to the battery 13 to the target display devices 10 via the communication module 23 (step S16).

The communication module 14 (antenna) included in the display device 10 receives the radio waves for feeding transmitted from the server device 20 (controller 22). The converting circuit 15 includes a rectifier circuit which converts the radio waves for feeding received by the communication module 14 into electric power (DC power) and outputs the DC power as a power source voltage. The electric power is thereby supplied to the battery 13 and the battery 13 is charged (step S17).

The display device 10 according to the present embodiment can charge the battery 13 by executing communication with the server device 20 (i.e., receiving the radio waves for feeding from the server device 20) as explained above. The radio waves for feeding are assumed to be, for example, radio waves having the frequency fixed. According to this, the power receiving efficiency can be improved by designing the antenna on the power receiving side for an exclusive frequency. Therefore, the charging efficiency of the battery 13 can be improved. In addition, the radio waves for display and the radio wave for feeding include data indicating the type of the radio waves (signals), and the display device 10 is capable of distinguishing the radio waves for display and the radio wave for feed, based on the data.

If it is determined that the electric power does not need to be fed to the battery 13 in the above-explained feed determination in step S14, the processing shown in FIG. 7 is terminated.

For example, feeding to the battery 13 included in the target display device 10 (i.e., the processing in steps S16 and S17) is continued for a predetermined period. In other words, feeding is terminated when a predetermined period has passed (step S18). In this case, the controller 22 included in the server device 20 stops transmission of the radio waves for feeding.

If the processing in step S18 is executed, the controller 22 requires the remaining battery of the target display device 10 via the communication module 23 (step S19).

The controller 12 included in the target display device 10 acquires the remaining battery in response to the requirement from the server device 20 (step S20).

If the processing in step S20 is executed, the controller 12 transmits (the data indicating) the remaining battery acquired in step S12 to the server device 20 in response to the requirement from the server device 20 (step S21).

Next, the controller 22 included in the server device 20 receives the remaining battery transmitted in step S21 via the communication module 23. The controller 22 executes abnormality determination, based on the received remaining battery (step S22). The abnormality determination is the processing for determining whether abnormality occurs in feeding (power supply) to the battery 13 included in the target display device 10 or not. In the abnormality determination, for example, if the received remaining battery is smaller than a predetermined value (i.e., the battery 13 is not sufficiently charged by the processing in steps S15 to S17), it is determined that abnormality occurs in feeding to the battery 13. In the abnormality determination, for example, if a difference between the remaining battery acquired in step S12 and the remaining battery acquired in step S20 is smaller than a predetermined value, it may be determined that abnormality occurs in feeding to the battery 13.

If it is determined that abnormality occurs in feeding to the battery 13, the output circuit 24 outputs alert to notify the manager, employee or the like of the store of the abnormality, under control of the controller 22 (step S23).

According to the above-explained processing in steps S19 to S23, alert can be output in a case where, for example, the battery 13 is not appropriately charged by the processing in steps S15 to S17.

If it is determined that abnormality does not occur in feeding to the battery 13 in the abnormality determination in step S22, the processing shown in FIG. 7 is terminated.

Charging the battery 13 included in one display device 10 has been explained with reference to FIG. 7, but the processing shown in FIG. 7 is executed between all of the display devices 10 attached to the display shelves in the store (i.e., all of the display devices 10 included in the electronic shelf label system) and the server device 20.

In the present embodiment as explained above, the electric power obtained by the communication between the display device 10 and the server device 20 (external device) is supplied to the battery 13 (storage). More specifically, the display device 10 includes the antenna (communication module 14) which receives the radio waves transmitted from the server device 20, converts the radio waves received by the antenna into electric power, and supplies the electric power to the battery 13.

The above-explained antenna is configured to receive the radio waves for display (first radio waves) and the radio waves for feeding (second radio waves). If the radio waves for display are received by the antenna, the product data acquired from the radio waves for display are displayed on the display panel. If the radio waves for feeding are received by the antenna, the battery 13 is charged by converting the radio waves for feeding into electric power.

In the present embodiment with such a configuration, since the work of individually exchanging the batteries 13 of the respective display devices 10 in the electronic shelf label system does not need to be executed, convenience of the electronic shelf label system can be improved.

In the present embodiment, charging the batteries 13 of the respective display devices 10 by periodically executing the above-explained processing shown in FIG. 7 has been explained, but the processing shown in FIG. 7 may be executed in a predetermined time zone alone.

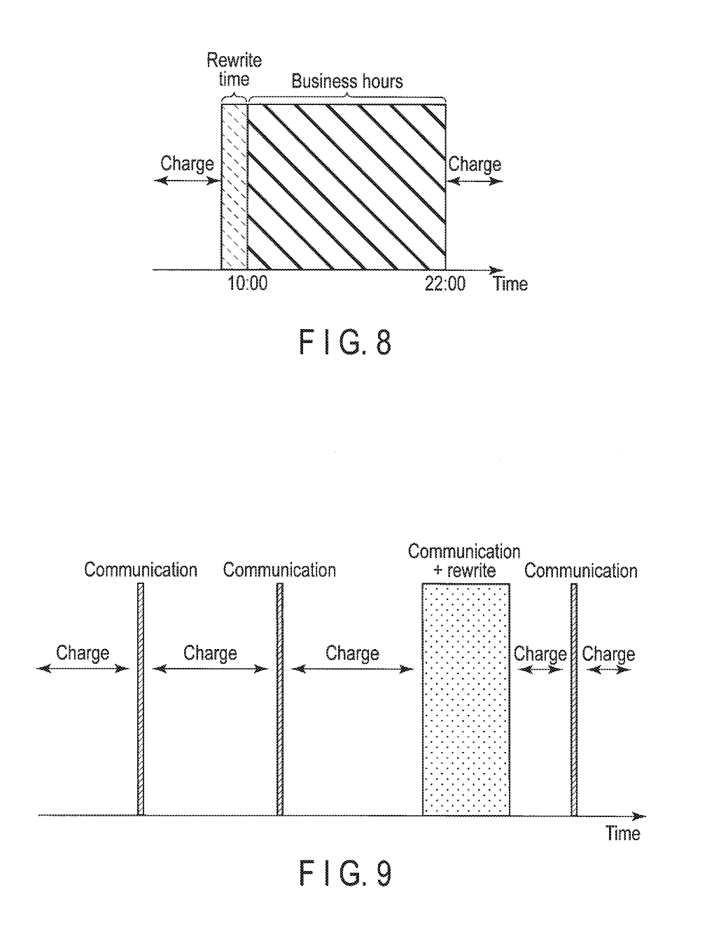

As shown in FIG. 8, it is assumed that business hours of the store where the display devices 10 according to the present embodiment are attached to the display shelves are ten o'clock to twenty-two o'clock. In the electronic shelf label system, for example, the product data displayed on all of the display devices 10 are often rewritten before the business hours.

In this case, the above-explained processing shown in FIG. 7 may be executed in the time band (charging time) except for the business hours of the store and the time to rewrite the product data before the business hours (i.e., the time necessary to rewrite the product data in all of the display devices 10).

In addition, as shown in FIG. 9, the communication is periodically executed between the display devices 10 and the server device 20 during the business hours and the rewriting time. The communication shown in FIG. 9 includes, for example, processing in step S1 shown in FIG. 6 (i.e., an inquiry on necessity to rewrite the product data from the display devices 10 to the server device 20).

As explained with reference to FIG. 6, if it is determined that rewriting the product data is necessary as a result of the inquiry on the necessity to rewrite the product data from the display devices 10 to the server device 20, the product data displayed on the display devices 10 are rewritten by executing the processing in steps S2 to S4.

In the present embodiment, the batteries 13 of the display devices 10 may be charged in the time other than the charging time except for the business hours and the rewriting time before the business hours shown in FIG. 8 (i.e., during the business hours and the rewriting time). For example, the batteries 13 may be charged in the time (time band) other than the period when the communication is executed between the display devices 10 and the server device 20 and the period when the product data displayed on the display devices 10 are rewritten as shown in FIG. 9.

In the present embodiment, feeding can be appropriately executed for the only battery 13 that requires feeding by executing the feed determination in step S14 shown in FIG. 7, but the battery 13 may be fed in, for example, a predetermined time band (or periodically) without executing the feed determination. In this case, the processing in steps S11 to S13 shown in FIG. 7 can be omitted.

In addition, in the present embodiment, it can be notified that the battery 13 cannot be appropriately fed (or the battery 13 is not charged) (i.e., alert can be output) by executing the abnormality determination in step S22 shown in FIG. 7, but the abnormality determination may not be executed. In this case, the processing in steps S19 to S23 shown in FIG. 7 can be omitted.

In the present embodiment, the above-explained configuration is employed since the work such as charging each of the display devices 10 (the batteries 13) is unnecessary, but the display device 10 is preferably operated in the manner of saving the power. If the electrophoretic display panel is used as the display panel for displaying the product data as explained above, the display device 10 may be operated in the power saving mode (sleep mode) at the time other than, for example, the time to rewrite the product data displayed on the display device 10 or the time to charge the battery 13 of the display device 10, since display of the product data can be maintained without supplying electric power by the display retaining property.

In addition, in the present embodiment, the radio waves for feeding received by the display device 10 (antenna) are converted into the electric power, which is supplied to the battery 13, but, for example, the electric power may be supplied to the battery 13 with an induced current caused by the electromagnetic induction when the antenna receives the radio waves for feeding.

That is, the present embodiment can be applied to the electronic shelf label system and the display device 10 having a configuration of supplying the electric power obtained by the communication with the external device such as the server device 20 to the power storage unit such as the battery 13.

In the present embodiment, the external device executing communication with the display device 10 when charging with the battery 13 is the server device 20. However, for example, if a mesh network capable of communication between the display devices 10 is constructed, the batteries 13 of the display devices 10 can be charged by transmitting and receiving the radio waves for feeding between the display devices 10.

### Second Embodiment

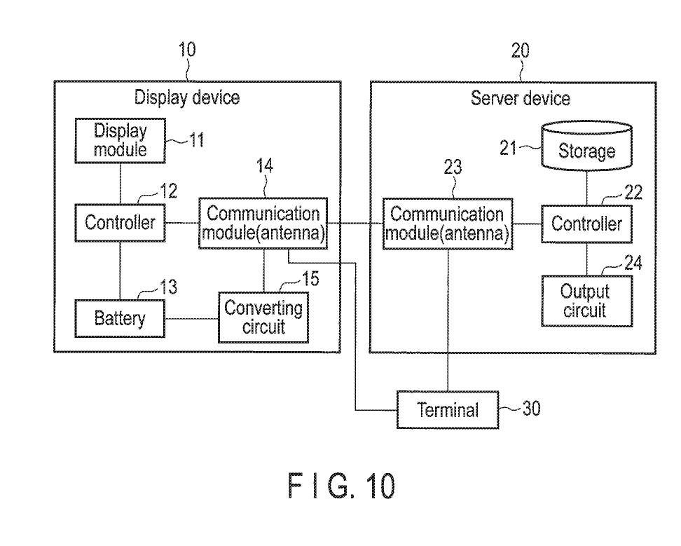

Next, a second embodiment will be explained. FIG. 10 is a block diagram showing an example of a configuration of an electronic shelf label system according to the present embodiment. In FIG. 10, the same elements as those shown in FIG. 2 are denoted by the same reference numerals and their detailed descriptions are omitted. Different elements from FIG. 2 will be hereinafter explained mainly. In addition, FIG. 10 shows only one display device 10 for convenience, and illustration of the other display devices 10 is omitted.

As shown in FIG. 10, an electronic shelf label system according to the present embodiment is different from the above-explained first embodiment in that the electronic shelf label system includes a terminal 30 dedicated to feeding besides the display device 10 and the server device 20.

The terminal 30 is a dedicated terminal device which transmits radio waves for supplying the electric power (radio waves for feeding) to a battery 13 included in the display device 10.

The radio waves for feeding transmitted by the terminal 30 are received by a communication module 14 (antenna). A converting circuit 15 converts the radio waves for feeding received from the terminal 30 by the antenna into the electric power and supplies the electric power to the battery 13.

Next, operations of the electronic shelf label system (display device 10, server device 20, and terminal 30) according to the present embodiment will be explained. Processing of rewriting the product data of the display device 10 in the electronic shelf label system is the same as the above-explained processing shown in FIG. 6, and its detailed explanations are omitted.

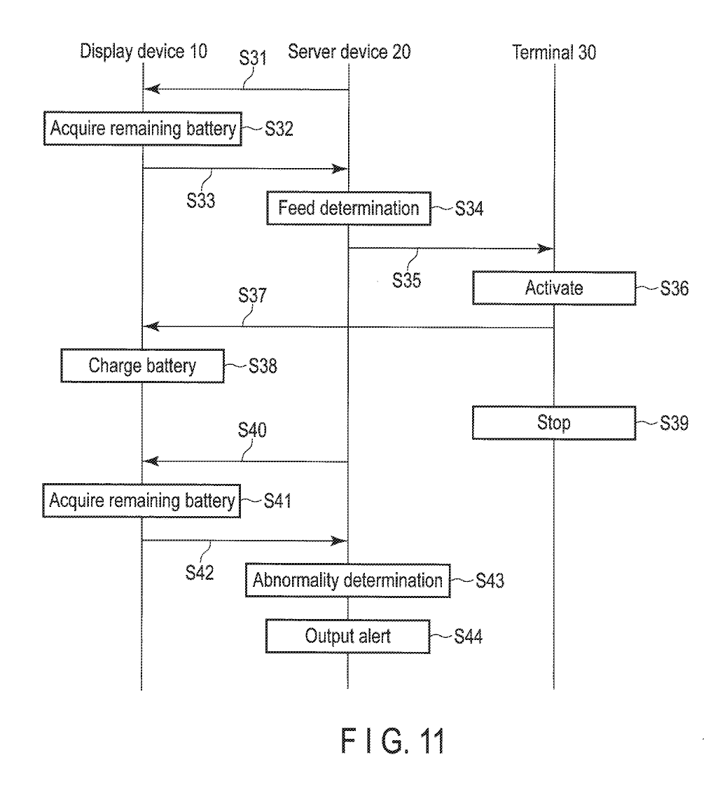

A processing procedure of charging the battery 13 included in the display device 10 of the electronic shelf label system will be explained with reference to a sequence chart shown in FIG. 11.

First, processing in steps S31 to S34 corresponding to the processing in steps S11 to S14 shown in FIG. 7 is executed. The display device 10 serving as a requirement destination of data (remaining battery) in step S31 is referred to as a target display device 10.

If it is determined that the electric power needs to be fed to the battery 13 in the feed determination in step S34, the server device 20 (the controller 22) requires feeding to the battery 13 to the terminal 30 (step S35).

If the processing in step S35 is executed, the terminal 30 is activated in response to the requirement from the server device 20 (step S36).

Next, the terminal 30 transmits the radio waves for feeding to feed (supply) the electric power to the battery 13 to the target display devices 10 (step S37).

The communication module 14 (antenna) included in the display device 10 receives the radio waves for feeding transmitted from the terminal 30. The converting circuit 15 converts the radio waves for feeding received by the antenna into the electric power and supplies the electric power to the battery. The battery 13 is thereby charged (step S38).

The display device 10 according to the present embodiment can charge the battery 13 by executing communication with the terminal 30 (i.e., receiving the radio waves for feeding from the terminal 30) as explained above. The radio waves for feeding transmitted from the terminal 30 are radio waves having a higher strength than, for example, the radio waves transmitted from the server device 20.

For example, if it is determined that the electric power does not need to be fed to the battery 13 in the feed determination in step S34, the processing shown in FIG. 11 is terminated.

For example, feeding to the battery 13 included in the target display device 10 (i.e., the processing in steps S37 and S38) is continued for a predetermined period. In other words, feeding is terminated when a predetermined period has passed. In this case, the terminal 30 (the operation of the terminal 30) is stopped (step S39). The terminal 30 may be automatically stopped when a predetermined period has passed or may be stopped when stopping feeding to the battery 13 is required by the server device 20.

As explained above, if the terminal 30 is stopped (i.e., if feeding is terminated), processing in steps S40 to S44 corresponding to the processing in steps S19 to S23 shown in FIG. 7 is executed. If it is determined that abnormality does not occur in feeding to the battery 13 in the abnormality determination in step S43, the processing shown in FIG. 11 is terminated.

Charging the battery 13 included in one display device 10 has been explained with reference to FIG. 11, but the processing shown in FIG. 11 is executed between all of the display devices 10 attached to the display shelves in the store (i.e., all of the display devices 10 included in the electronic shelf label system) and the server device 20.

As explained above, in the present embodiment, the display device 10 is connected to the server device 20 and the terminal 30 dedicated to feeding so as to enable communication, and the communication module 14 (antenna) receives radio waves for display (first radio waves) from the server device 20 and receives radio waves for feeding (second radio waves) from the terminal 30. If the radio waves for display are received by the antenna, the product data acquired from the radio waves for display are displayed on the display panel. If the radio waves for feeding are received by the antenna, the battery 13 is charged by converting the radio waves for feeding into electric power.

The above-explained terminal 30 is a dedicated terminal device prepared to feed the electric power to the battery 13 of the display device 10, and is configured to emit (transmit) radio waves stronger than the radio waves for feeding transmitted from the server device 20 as explained above in the first embodiment. In the present embodiment, the battery 13 of the display device 10 can be charged more efficiently than the first embodiment by transmitting the radio waves for feeding from the terminal 30.

For example, the terminal 30 may be configured to have directivity. Since the terminal 30 having the directivity is capable of emitting strong radio waves in a specific direction, the efficiency of charging, for example, the battery 13 of the display device 10 located in the specific direction can be further improved.

In the present embodiment, for example, if the products related to the product data displayed on a specific display device 10 (i.e., the products disposed near the display device 10) are sale-priced products, the product data displayed by the display device 10 may be urged to blink.

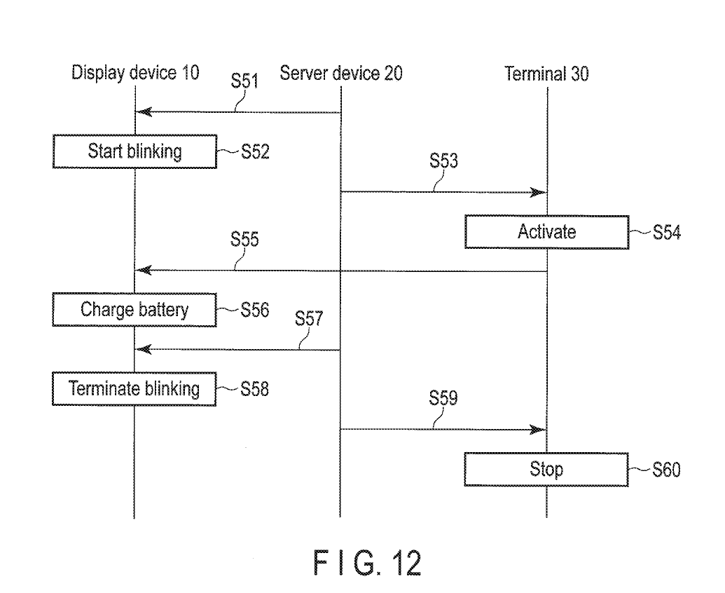

A processing procedure of urging the product data to blink on the specific display device 10 (hereinafter referred to target display device 10) will be explained with reference to a sequence chart shown in FIG. 12.

If the product data are urged to blink on the target display device 10 as explained above, the server device 20 (the controller 22) instructs the target display device 10 to start the operation in a mode of urging the product data to blink (hereinafter referred to as sales mode) (step S51). For example, the start of the operation in the sales mode is assumed to be instructed if a time preset in the server device 20 (i.e., a sales mode start time) comes.

In this case, blinking the product data in accordance with the instruction from the server device 20 is started on the target display device 10 (step S52).

Blinking the product data on the target display device 10 is implemented by alternately transmitting the radio waves for display to display the product data and the radio waves to make the product data undisplayed (radio waves for non-display) from the server device 20 to the target display device 10 (i.e., repeating display and non-display of the product data).

As explained above, if blinking the product data on the target display device 10 is started, processing in steps S53 to S56 corresponding to the processing in steps S35 to S38 shown in FIG. 11 is executed. According to this, the battery 13 included in the target display device 10 is charged with the radio waves for feeding transmitted from the terminal 30. The radio waves for display and the radio waves for non-display are alternately transmitted in the blink of the product data while, in step S55, the radio waves for feeding are transmitted between transmission (timing) of the radio waves for display and the radio waves for non-display.

If the product data are urged to blink as explained above, the operations of urging the product data to be displayed in accordance with reception of the radio waves for display and urging the product data to be undisplayed in accordance with reception of the radio waves for non-display need to be repeated on the target display device 10. For this reason, power consumption on the target display device 10 is increased as compared with that in a case of maintaining the display of the product data based on the above-explained display retaining property.

Therefore, if the product data are urged to blink on the target display device 10, the battery 13 of the target display device 10 having larger power consumption is preferably charged efficiently by transmitting the radio waves for feeding to the target display device 10 by the terminal 30 having the directivity as explained above.

The server device 20 (the controller 22) instructs termination of the operation in the above-explained sales mode (step S57). For example, termination of the operation in the sales mode is assumed to be instructed, if a predetermined period has passed after the start of operation in the sales mode has been notified, or if a preset time (sales mode termination time) has come.

In this case, blinking the product data in accordance with the instruction from the server device 20 is terminated on the target display device 10 (step S58).

If the processing in step S58 is executed, the server device 20 notifies the terminal 30 that the operation in the sales mode has been terminated (step S59).

The terminal 30 stops its operation in response to the notification from the server device 20 (step S60).

According to the above-explained processing shown in FIG. 12, for example, even in a case of urging the product data to blink on a specific display device 10, the battery 13 of the display device 10 can be charged appropriately.

If the target display device 10 is operated in the above-explained sales mode, the sales price (i.e., a price lower than an ordinary price) is often urged to blink as the product data on the target display device 10. For this reason, if the processing in FIG. 12 is terminated (i.e., blink of the product data is terminated), the product data are rewritten to display the ordinary price on the target display device 10 by executing the above-mentioned processing shown in FIG. 6.

In addition, in the processing shown in FIG. 12, the radio waves for display and the radio waves for non-display for the product data are alternately transmitted from the server device 20 to the target display device 10. If the radio waves for display are received by the target display device 10, the product data are displayed. If the radio waves for non-display are received, the product data are made undisplayed. Therefore, blink of the product data is implemented. To charge the battery 13 of the target display device 10 in this case, the terminal 30 needs to transmit the radio waves for feeding to the display device 10 at timing different from the timing of the radio waves for display and the radio waves for non-display.

In contrast, if a storage device such as a memory is provided in the target display device 10, for example, control of preliminarily storing in the memory the product data acquired from the radio waves for display transmitted by the server device 20 in the start of operation in the sales mode, and repeating the display and non-display of the product data on the target display device 10 side using the product data stored in the memory (i.e., urging the product data to blink), can be executed. In such a configuration, since the target display device 10 does not need to repeat receiving the radio waves for display and the radio waves for non-display, the terminal 30 can transmit the radio waves for feeding to the target display device 10 at any time and the charging efficiency can be improved.

In the present embodiment, the terminal 30 which transmits the radio waves for feeding is prepared independently of the server device 20 but, if the terminal 30 is installed at a predetermined place, the intensity of the radio waves for feeding received by the predetermined display device 10 is often lowered due to the distance from the terminal 30 or its environment, and the charging efficiency of the battery 13 of the display device 10 is often lowered.

For this reason, in the present embodiment, the terminal 30 may be installed on, for example, a cart moving inside a store or held by a clerk moving inside the store. Furthermore, a mobile body equipped with the terminal 30 may automatically move inside the store. According to such a configuration, for example, reduction in the charging efficiency of the battery 13 according to the position where the display device 10 is attached, or the like can be suppressed. In addition, feeding can be executed in a state where each display device 10 and the terminal 30 are made to be more close to each other, and improvement of the charging efficiency can be attempted.

In addition, even if the terminal 30 is installed at a predetermined position, reduction in the charging efficiency of the battery 13 of the display device 10 may be suppressed by installing a relay equipment which relays the radio waves for feeding between the display device 10 attached to a position where, for example, the intensity of the radio waves for feeding is lowered, and the terminal 30. The relay equipment may be installed on a cart or the like as explained above.

### Third Embodiment

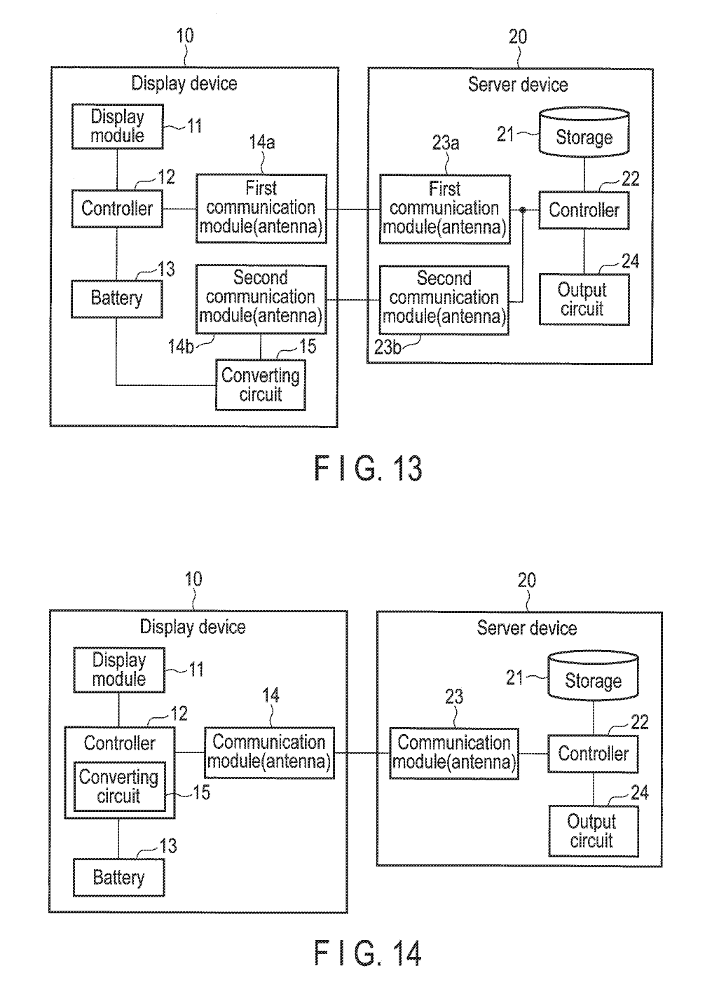

Next, a third embodiment will be explained. FIG. 13 is a block diagram showing an example of a configuration of an electronic shelf label system according to the present embodiment. In FIG. 13, the same elements as those shown in FIG. 2 are denoted by the same reference numerals and their detailed descriptions are omitted. Different elements from FIG. 2 will be hereinafter explained mainly. In addition, FIG. 13 shows only one display device 10 for convenience, and illustration of the other display devices 10 is omitted.

As shown in FIG. 13, the electronic shelf label system according to the present embodiment is different from the above-explained first embodiment in that the display device 10 includes a first communication module 14a and a second communication module 14b, and the server device 20 includes a first communication module 23a and a second communication module 23b.

The first communication module 14a included in the display device 10 includes a first antenna to communicate with the server device 20. The first antenna receives radio waves for display transmitted from the server device 20 to display the product data managed by the server device 20 on the display panel.

The second communication module 14b included in the display device 10 includes a second antenna to communicate with the server device 20. The second antenna receives the radio waves for feeding transmitted from the server device 20 to supply the electric power to the battery 13 includes in the display device 10.

In the present embodiment, the controller 22 included in the server device 20 transmits the radio waves for display to the display device 10 via a first communication module 23a. In addition, the controller 22 transmits the radio waves for feeding to the display device 10 via a second communication module 23b.

That is, in the electronic shelf label system of the present embodiment, each of the display device 10 and the server device 20 includes a communication module (first communication module 14a and first communication module 23a) for transmission and reception of the radio waves for display, and a communication module (second communication module 14b and second communication module 23b) for transmission and reception of the radio waves for feeding.

In the present embodiment, the radio waves for display transmitted from the server device 20 via the first communication module 23a are received by the first communication module 14a (first antenna) of the display devices 10 and the radio waves for feeding transmitted from the server device 20 via the second communication module 23b are received by the second communication module 14b (second antenna) of the display devices 10, but other operations of the electronic shelf label system according to the present embodiment are the same as the above-explained first embodiment. Therefore, their detailed explanations are omitted.

In the present embodiment as explained above, the display device 10 includes the first antenna (first communication module 14a) configured to receive the radio waves for display (first radio waves) transmitted from the server device 20 (first communication module 23a), and the second antenna (second communication module 14b) configured to receive the radio waves for feeding (second radio waves) transmitted from the server device 20.

In the present embodiment with such a configuration, since the radio waves for feeding can be received by the second antenna without receiving an influence from the radio waves for display, the battery 13 can be charged efficiently.

In the present embodiment, for example, the radio waves for display and the radio waves for feeding may be transmitted on different channels to avoid interference between the radio waves for display and the radio waves for feeding.

In addition, in the present embodiment, the radio waves for feeding are transmitted from the server device 20 via the second communication module 23b, but the radio waves for feeding may be transmitted from the terminal 30 dedicated to feeding as explained in the second embodiment.

### Fourth Embodiment

Next, a fourth embodiment will be explained. FIG. 14 is a block diagram showing an example of a configuration of an electronic shelf label system according to the present embodiment. In FIG. 14, the same elements as those shown in FIG. 2 are denoted by the same reference numerals and their detailed descriptions are omitted. Different elements from FIG. 2 will be hereinafter explained mainly. In addition, FIG. 14 shows only one display device 10 for convenience, and illustration of the other display devices 10 is omitted.

As shown in FIG. 14, an electronic shelf label system according to the present embodiment is different from the above-explained first embodiment in that a controller 12 and a converting circuit 15 are integrated in the display device 10.

Operations of the electronic shelf label system according to the present embodiment are the same as those of the above-explained first embodiment, and their detailed explanations are omitted. In the present embodiment, display of the product data and charging of the battery 13 are changed by the controller 12 and, for example, the battery 13 is charged in a remaining time other than the time for rewriting the product data on the display device 10.

In the present embodiment, the controller 12 and the converting circuit 15 of the display device 10 are integrated as explained above, and downsizing of the display device 10 can be implemented as compared with the above-explained first embodiment.

The present embodiment may be applied to the above-explained second and third embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device being enable communication with an external device, comprising:
a display panel;
a controller configured to control the display panel so as to display product data related to a product;
a battery configured to store electric power operating the display device; and
a power supply circuit configured to supply electric power to the battery, the electric power being obtained by the communication with the external device.

2. The display device of claim 1, further comprising an antenna configured to receive the electric power transmitted from the external device,
wherein
the power supply circuit is configured to convert the radio waves received by the antenna into the electric power and to supply the electric power to the battery.

3. The display device of claim 2, wherein
the antenna is configured to receive first radio waves transmitted from a server device in the external device in order to display a product data managed in the server device on the display panel and to receive second radio waves transmitted from the server device in order to supply the electric power to the battery,
the controller is configured to display the product data acquired from the first radio waves on the display panel when the first radio waves are received by the antenna, and
the power supply circuit is configured to convert the second radio waves into the electric power and to supply the electric power to the battery when the second radio waves are received by the antenna.

4. The display device of claim 2, wherein
the antenna is configured to receive first radio waves transmitted from a server device in the external device in order to display a product data managed in the server device on the display panel and to receive second radio waves transmitted from the terminal in order to supply the electric power to the battery,
the controller is configured to display the product data acquired from the first radio waves on the display panel when the first radio waves are received by the antenna, and
the power supply circuit is configured to convert the second radio waves into the electric power and to supply the electric power to the battery when the second radio waves are received by the antenna.

5. The display device of claim 2, wherein
the antenna comprises a first antenna configured to receive first radio waves transmitted from a server device in the external device in order to display a product data managed in the server device on the display panel and a second antenna configured to receive second radio waves transmitted from the server device in order to supply the electric power to the battery,
the controller is configured to display the product data acquired from the first radio waves on the display panel when the first radio waves are received by the first antenna, and
the power supply circuit is configured to convert the second radio waves into the electric power and to supply the electric power to the battery when the second radio waves are received by the second antenna.

6. The display device of claim 1, wherein the controller and the power supply circuit are integrated as one body.

7. The display device of claim 1, wherein the display panel includes an electrophoretic display panel.

8. An electronic shelf label system comprising a display device, and a server device being enable communication with the display device, wherein
the server device comprises a storage configured to store product data on a product, and
the display device comprises:
a display panel;
a first controller configured to control the display panel so as to display the product data on the display panel;
a battery configured to store electric power operating the display device; and
a power supply circuit configured to supply electric power to the battery, the electric power being obtained by communication with the server device.

9. The electronic shelf label system of claim 8, wherein
the server device comprises a second controller configured to acquire an amount of electric power stored in the battery from the display device and to determines whether the electric power needs to be supplied to the battery or not, based on the acquired amount of electric power,
the display device comprises an antenna configured to receive the radio waves transmitted from the server device when it is determined that the electric power needs to be supplied to the battery, and
the power supply circuit is configured to convert the radio waves received by the antenna into the electric power and to supply the electric power to the battery.

10. The electronic shelf label system of claim 9, wherein
the second controller is configured to acquire again from the display device the amount of electric power stored in the battery after supplying the electric power to the battery by the power supply circuit, and to further determine whether abnormality occurs in power supply to the battery or not, based on the amount of electric power acquired again, and
the server device is configured to output alert when it is determined that the abnormality occurs in the power supply to the battery.

11. The electronic shelf label system of claim 8, wherein
the server device is configured to transmit first radio waves in order to display the product data on the display panel and to transmit second radio waves to supply the electric power to the battery, via different antennas,
the display device comprises a first antenna configured to receive the first radio waves and a second antenna configured to receive the second radio waves,
the first controller is configured to display the product data acquired from the first radio waves by the first antenna, on the display panel, and
the power supply circuit is configured to convert the second radio waves received by the second antenna into the electric power and to supply the electric power to the battery.

12. An electronic shelf label system comprising a display device, a server device being enable communication with the display device, and a terminal, wherein
the server device comprises a storage configured to store product data on a product, and
the display device comprises:
a display panel;
a first controller configured to control the display panel so as to display the product data on the display panel;
a battery configured to store electric power operating the display device; and
a power supply circuit configured to supply electric power to the battery, the electric power being obtained by communication with the terminal.

13. The electronic shelf label system of claim 12, wherein
the server device acquires an amount of electric power stored in the battery from the display device and to determines whether the electric power needs to be supplied to the battery or not, based on the acquired amount of electric power,
the server device comprises a controller configured to activate the terminal when it is determined that the electric power needs to be supplied to the battery,
the display device comprises an antenna configured to receive the radio waves transmitted from the terminal activated in order to supply the electric power to the battery, and
the power supply circuit is configured to convert the radio waves received by the antenna into the electric power and to supply the electric power to the battery.

14. The electronic shelf label system of claim 12, wherein the terminal is configured to have directivity of emitting radio waves in a direction of the display device.
